(19) United States
(12) Patent Application Publication
(10) Pub. No.: US 2007/0013961 A1
(43) Pub. Date: Jan. 18, 2007

(54) Original document verification system and method in an electronic document transaction

(75) Inventor: Peter Hesse, Pines, FL (US)

Correspondence Address: Alan M. Weisberg;Christopher & Weisberg, P.A., Suite 2040, 200 East Las Olas Boulevard, Fort Lauderdale, FL, 33301, US

(73) Assignee: Ecloz, LLC

(21) Appl. No.: 11/180,168

(22) Filed: Jul. 13, 2005

(51) Int. Cl. H04N 1/00

(52) U.S. Cl. 358/403; 358/1.15

(57) ABSTRACT

A method and system for recording electronic documents through a data communication network while assuring that no duplicate “original” documents are in existence. The method and system includes creating an original electronic document that is to be recorded, such as a deed in a real estate transaction. The electronic document is stored on a source computer in an electronic file and, in one embodiment, transmitted to a recordation agency's computer over a data communication network for recordation. Upon submission of the document for recordation, the stored electronic document is designated as a “copy”. A file containing at least the original electronic document is then transmitted from the recordation agency to the source computer and stored thereon or transferred to another medium.

### CROSS-REFERENCE TO RELATED APPLICATION

n/a

### STATEMENT REGARDING FEDERALLY SPONSORED RESEARCH OR DEVELOPMENT

n/a

### FIELD OF THE INVENTION

The present invention relates to electronic document transactions, and in particular to an electronic document recordation system and method for assuring that only the original electronic document is recorded and for preventing multiple “original” documents from being generated and circulated through an online data communications network.

### BACKGROUND OF THE INVENTION

Commercial transactions, particularly real estate transactions, usually present anxieties for some or all of the parties involved. Part of the reason for this anxiety, other than the usual financial consideration, is the amount of paperwork involved. Lending institutions, mortgage brokers, purchasers, sellers, and notaries are presented with an enormous quantity of paper in a basic real estate transaction. Papers must be prepared, presented to all interested parties, examined and executed by the interested parties and routed to other parties in the transaction “chain”. Papers necessary to the transaction can become lost or misplaced. Needless to say, the flurry of paperwork can bog down the transaction process and present difficulties if one or more of the papers becomes lost. In recent years, as more and more people have become accustomed to conducting business via the Internet, online electronic recordation models have been created to eliminate the problems inherent in paper-routing transactions. While streamlining the “paper process”, online electronic recordation models are not without their own set of inherent problems.

While models are designed to assure that data in the electronic documents cannot be tampered with by the use of public and private keys, one critical concern that remains in electronic document recordation models is the problem of how to handle original documents. Since online real estate transactions often involve more than one person having to sign the same document, a problem arises when more than one “original” document appears on the scene.

In many real estate transactions, recordation offices such as the County Recorder require that one “original” document be digitally signed by all of the interested parties, notarized and sent to it for recordation. After recordation, the “original” recorded document containing all of the original digital signatures and recordation information must then be returned to the sender of the document, where a user can print it or request that it be printed out. In the paper world, it is typically easy to identify signed documents that are duplicates of the originals. Original signatures can be differentiated fairly easily from their faxed reproductions. However, since electronic documents are digitally signed, it is very difficult to determine from two digitally signed documents which is the original and which is an electronic copy. With the proliferation of computers, it is extremely easy for a user to duplicate the originally signed document and store it on their own computer for later, possible fraudulent use. Thus, there is a distinct possibility that more than one “original” recorded electronic document can be in existence at one time. It is therefore desirable to have an electronic document recordation system and method that assures only the original document is submitted for recordation.

It is further desirable to have an electronic document recordation system and method that prevents the duplication of the original document, thus assuring that only the original document is processed.

It is also desirable to have an electronic mortgage recordation system that complies with the requirements of the Property Records Industry Association (PRIA).

### SUMMARY OF THE INVENTION

The present invention addresses the deficiencies of the art with respect to electronic document recordation systems and provides a novel and non-obvious method and system for routing an original electronic document to a document recording agency via a data communication network and receiving a recorded original electronic document while assuring that no other original electronic documents are in existence.

In accordance with the present invention, a method of processing an electronic document in an electronic document recordation system to assure the existence of only one original electronic document is provided. The method includes storing an original electronic document on a source computer, submitting the original electronic document for recordation, and upon verification that the original electronic document has been submitted for recordation, designating the stored electronic document on the source computer as a copy of the original electronic document.

In another aspect of the invention, a machine readable medium having instructions stored thereon for execution by a processor to perform a method of processing an electronic document in an electronic document recordation system in order to assure the existence of only one original electronic document is provided. The method includes storing an original electronic document on a source computer, submitting the original electronic document for recordation, and upon verification that the original electronic document has been submitted for recordation, designating the stored electronic document on the source computer as a copy of the original electronic document.

In an additional aspect of the invention, a system for processing an electronic document in an electronic document recordation system to assure the existence of only one original electronic document is provided. The system includes a source computer connected to a destination computer via a data communications network, for storing an original electronic document. The source computer includes means for transmitting the original electronic document to the destination computer over the data communication network, and means for designating the stored electronic document on the source computer as a copy of the original electronic document, upon verification that the original document has been transmitted to the destination computer.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a exemplary embodiment of the components of the electronic recordation system of the present invention;

FIG. 2 is a flow chart illustrating an exemplary embodiment of the process performed by the present invention;

FIG. 3A is a flow chart illustrating an alternate embodiment of the process performed by the present invention;

FIG. 3B is a continuation of a flow chart illustrating the alternate embodiment of the process performed by the present invention; and

FIG. 3C is a further continuation of a flow chart illustrating the alternate embodiment of the process performed by the present invention.

### DETAILED DESCRIPTION OF THE INVENTION

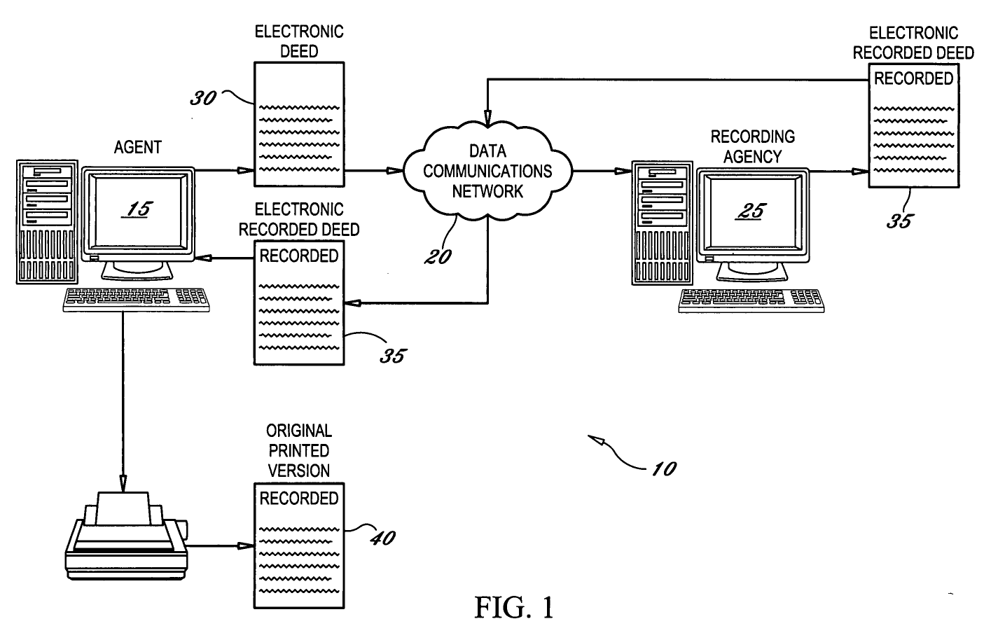

Referring now to the drawing Figures in which like reference designators refer to like elements, there is shown in FIG. 1 an exemplary embodiment of the electronic document recordation system 10 of the present invention in its most basic form. Although the inventive process described herein is applicable to any electronic document recordation process, the example shown in the figures relates to an online real estate transaction involving the recordation of an electronic deed.

System 10 includes computer 15, which stores a software program in its memory that embodies the present invention. Computer 15 is part of a data communications system and may be one or more computers capable of sending and retrieving electronic signals containing information via data communications network 20. Thus, although the term “first” or “source” computer is used when describing the computer that transmits an electronic document and receives a recorded version of the electronic document from the destination computer, the receiving computer need not be identical to the computer 15 that transmitted the document to the destination computer.

Computer 15 may reside at, for example, a closing or title agent's office whose task it is to coordinate all interested parties, obtain relevant signatures, have the deed notarized and route the deed to the County Recorder's office for recordation. The agent's computer 15 is in electronic communication with a computer or computers at a recording agency 25 via data communications network 20. Recording agency 25 is typically the County Recorder that must record all deeds in a real estate transaction. Typically, data communications network 20 is the Internet, although the invention is equally adaptable over an intranet or virtual network, a dial-up network, or any network capable of communicating data between user terminals.

The system shown in FIG. 1 employs an inventive process that will be explained in greater detail below. In an electronic document recordation system employing an embodiment of the invention, an original electronic deed 30 is created and transmitted over network 20 to a computer or computers 25 at the recording agency. The recording agency computer 25 confirms that the deed conforms with the necessary legal requirements, and after the recording agency has recorded the deed and affixed the recording information, it transmits the original deed 30 back in recorded form 35 over network 20, where it is received by the agent's computer 15, or a different computer authorized by the closing or title agent to receive recorded documents.

Once received, the original document containing the affixed recordation information can be stored on the receiving computer, or transferred to another medium. For example, the original document can be transferred to another data storage device such as a compact disc or another computer. Or, the original document can be printed. If the printed document is to be designated as the new “original” document, prior to printing, the computer makes a duplicate of the original, stored document and date and time stamps the duplicate thus “locking in” the stored document as a “copy”. The printed document now becomes the new “original” document. If the printed version of the document is to be merely a copy, the stored version remains designated as the “original” and the stored document need not be duplicated or time-stamped.

When the original electronic document 30 is transmitted back to computer 15 over network 20, the recordation information may be included in an electronic file along with the original document 30. In this instance, the recipient of the electronic file or a person designated by the recipient may apply the recordation information to the original electronic deed 30.

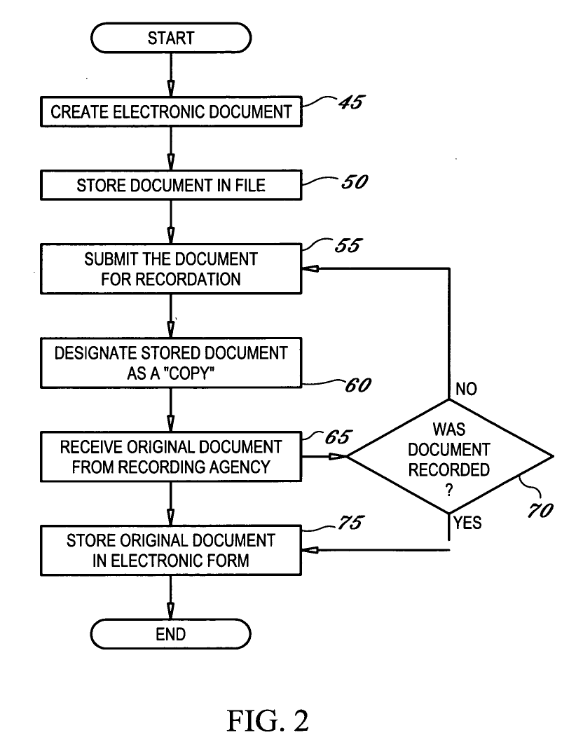

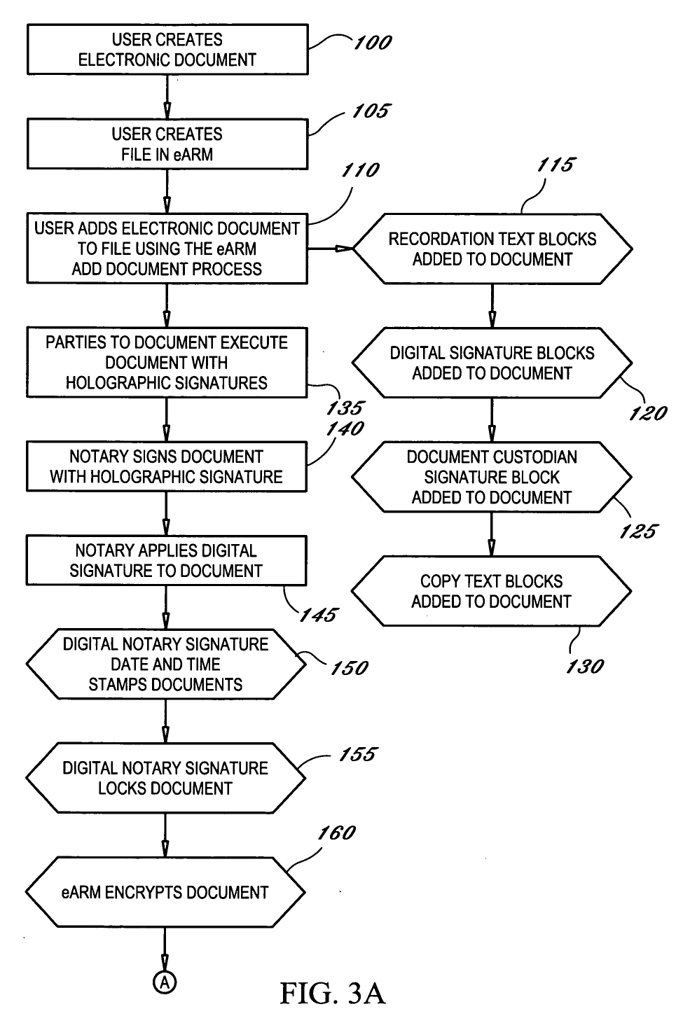

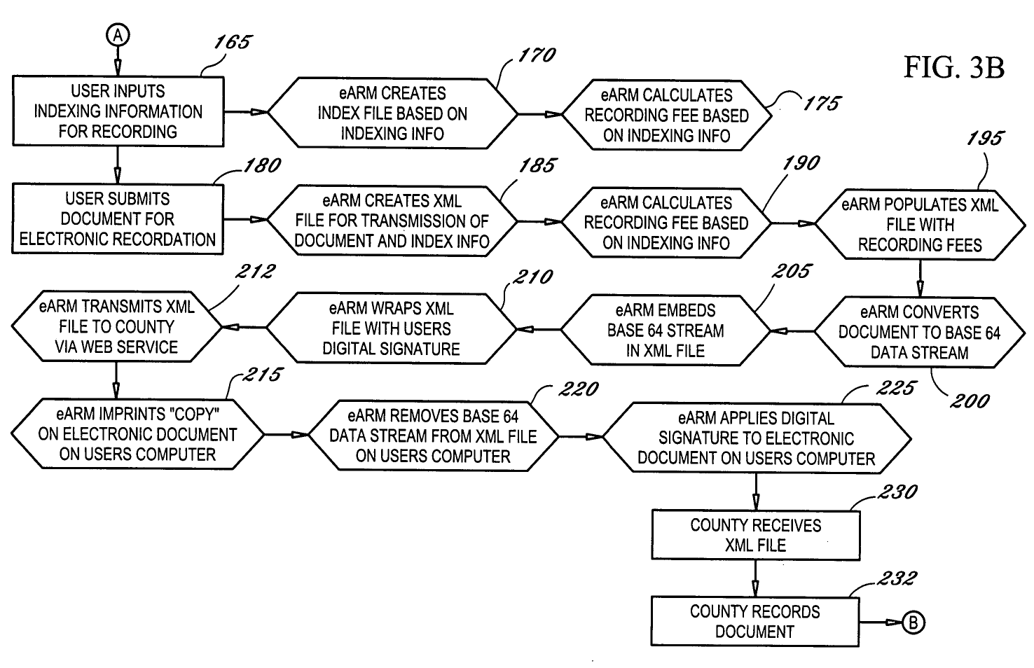

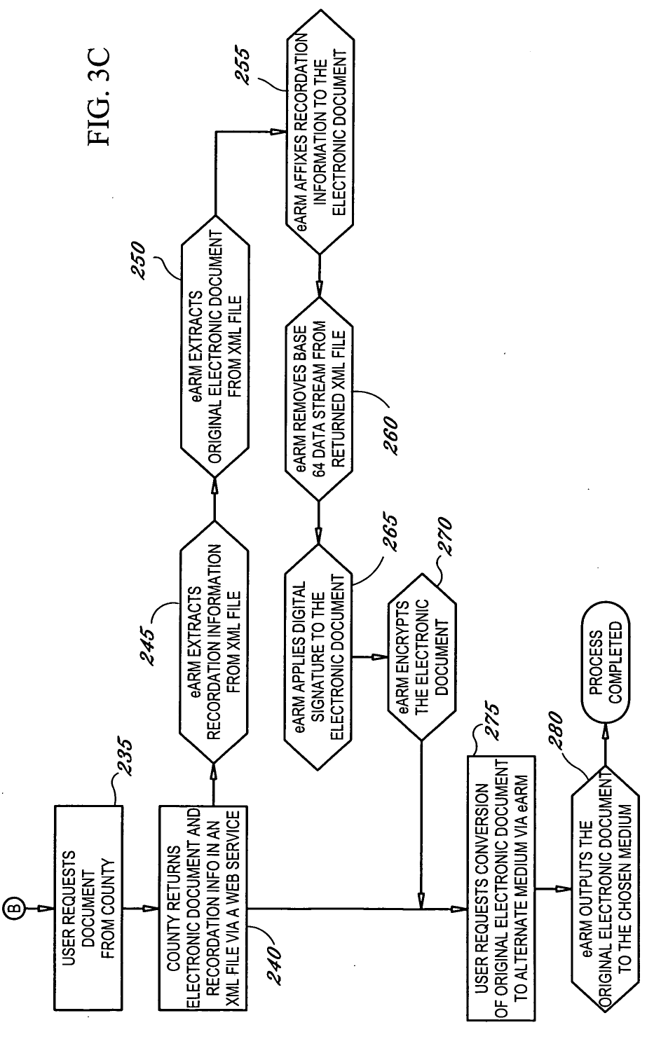

A series of steps assuring that only one “original” deed exists at any one time are taken prior to transmission of electronic deed 30, upon receipt of deed 30 by the recording agency, and upon receipt of the recorded deed 35 via network 20 by the closing or title agent. These steps are explained in greater detail below and depicted in FIGS. 2 and 3A-3C.

FIG. 2 illustrates an exemplary recordation process of the present invention. The process flow shown in FIG. 2 begins with the creation of an original electronic document, i.e. deed 30. A user creates the electronic document using any Windows based application capable of producing an electronic image of the document, for example, a document created in Adobe® PDF (Portable Document Format). Once deed 30 is created in an electronic format, via step 45, and digitally signed by all of the interested parties, it is stored in a computer file, step 50. At this time, the stored and executed electronic deed 30 is the only version of the executed deed in existence, and is therefore referred to as the “original”.

Once deed 30 is digitally signed by all the interested parties, it is submitted for recordation. Typically, this includes electronically transmitting the deed 30 to a computer server 25 at a recording agency, via step 55, whose function is to record the original deed. The recording agency is defined herein as any entity capable of recording documents. As soon as deed 30 is submitted to the recording agency for recordation, the electronic deed 30 stored on computer 15 is designated as a “copy”, via step 60. This is typically done by embedding a digital time and date “stamp” in the document, which confirms that the document is a copy of the original. Thus, there can be no confusion is to which is the “original” executed electronic deed 30. Only the deed submitted for recordation is considered “original”, since the document now stored on computer 15 has been digitally altered and designated as a “copy” and is visually distinguishable from the “original” deed submitted for recordation.

Although the embodiment discussed herein assumes that a recordation agency having a destination computer 25 is responsible for recording the deed 30, the invention may also be adapted to a scenario where the closing or title agent (the creator of the document) is “deputized” by the County and may also record the document. In this scenario, there is no need to transmit deed 30 to a destination computer for recordation. Thus, step 55, “submitting the document for recordation”, may include printing out the original deed, perhaps at agent's computer 15, designating the stored electronic version of the deed as a “copy” and recording the printed version of the original document, where the actual recording may be done by the closing or title agent or by a third party.

Once the recording agency receives deed 30, it is recorded and the recorded deed 35 is transmitted via network 20 back to the agency's computer 15, via step 65. If the recording agency could not record the deed 30, i.e., if there was something defective in the deed, the agency may have to re-submit the deed. Thus, the sender of deed 30 must first verify if the deed 30 has been recorded, via step 70. If deed 30 has not been recorded, the sender, after taking corrective action, re-submits the deed, via step 55. If the deed has been recorded, digital signatures are applied to the received recorded deed 35 in order to prevent alteration of the recordation information. Recorded deed 35 may also encrypted to prevent unauthorized opening and altering of the document. Thus, only one copy of the original document exists, i.e. the recorded document received by agent's computer 15, via step 65. The original deed 30, now having been signed by the interested parties and recorded by the recording agency, is stored on the agent's computer 15 as the “original” deed, via step 75, and, if needed, may be printed.

FIGS. 3A through 3C illustrate a more detailed embodiment of the electronic document recordation process of the present invention. Referring to FIG. 3A, a user first creates an electronic document 30 via step 100. As stated above, an electronic document can be created by any Windows based application such as Adobe® Acrobat®, which creates an electronic document in PDF (Portable Document Format). An Electronic Automated Recordation Module (eARM) incorporating the inventive process disclosed herein then creates an electronic file, step 105, that receives the electronic document 30, via step 110. Although the present invention may be applied to any electronic document recording process, we shall use the example of a residential real estate transaction. The electronic document described herein shall therefore be defined as a deed, which requires signatures by the parties involved in the real estate transaction and which also must be recorded by a recording agency, such as the County Recorder. Because of the nature of electronic documents, it is desirable to assure that only the original deed is circulated to the various parties and the recording agency and to assure that no virtual “duplicate” deeds are created that may be confused with the original.

Once the electronic file containing deed 30 is created, deed 30 can be altered to add various text blocks that are needed for the recordation process. For example, blocks that are to receive recordation information are added at step 115, blocks that are to receive digital signatures of the interested parties are added at step 120, a block where the custodian of the document can sign may be added at step 125, and blocks that can display other information such as whether the document is an original or copy, and time and date information can be added at step 130. One or more of the text blocks indicated in steps 115 through 130 may be added after the creation of the electronic document file.

At step 135, the parties to the real estate transaction execute electronic document 30 by either digitally signing the document 30 in the text blocks created by step 120, or by holographically signing document 30 with the use of a digital graphics tablet with an electronic stylus. Deeds are typically notarized by a Notary Public or someone with equivalent ability to notarize documents. This requirement is also true for electronic versions of the deed. At step 140, a Notary Public signs the deed holographically. The Notary Public then applies his or her digital signature to the document, at step 145. Digitally signing the document applies a time and date stamp to the document, step 150, and “locks” the document, step 155, so that it cannot be digitally altered without the creator's authorization. The electronic document may be encrypted, via step 160, to prevent unauthorized tampering with the document. Any standard encryption technique may be used including a public key/private key security system.

Referring now to FIG. 3B, a continuation of the inventive process of FIG. 3A can be seen. The electronic file containing deed 30 is populated with indexing information that is required by the recordation agency, via step 165. This can be done either manually or automatically, via an electronic data link. Once the indexing information has been added, an index file is created via step 170 and the recording fees can be calculated based upon the indexing information via step 175. At this point, the electronic version of the deed is ready to be submitted to the recording agency for recordation, via step 180.

In one embodiment of the invention, electronic deed 30 is submitted to the recording agency via an electronic transmission through data communications network 20. A computer 25 at the recording agency is electronically linked, via network 20, to the computer 15 that stores electronic deed 30. Recording agencies typically require the electronic document to be in a particular format to enable it to be processed quickly and easily. A typical example is in electronic mortgage recordation transactions. The Property Records Industry Association (PRIA) requires that the electronic deed be transmitted in XML (Extensible Markup Language).

Using this example, an XML file is created, via step 185, and is populated with the indexing information, via step 190, and recording fees, via step 195, which were calculated at step 175 based upon the user inputted indexing information. The document is encoded in a predetermined scheme such as a Base64 Data Encoding scheme, via step 200. The encoded data stream is then embedded within the XML file, via step 205. Finally, the user's digital signature is applied to the XML formatted document, via step 210, and the XML document is ready to be transmitted to the recording agency.

The XML file containing electronic deed 30, indexing and recordation information, and the user's digital signature, is transmitted via network 20 to the computer 25 at the recording agency, via step 212. As soon as deed 30 is transmitted to the recording agency, the version of the deed on computer 15 is designated as a “copy” by embedding digital text on the document (e.g. “COPY” or “SUBMITTED FOR RECORDING”), via step 215, deleting the encoded data stream from the XML file on computer 15, via step 220, and adding a digital signature to the document, via step 225. Steps 215 through 225 insure that the digital text embedded within the electronic deed cannot be removed without invalidating the digital signature. The County Recorder receives the XML file containing original deed 30, via step 230 and the deed is recorded, at step 232.

Referring now to FIG. 3C, which is a continuation of the flowcharts of FIGS. 3A and 3B, a user submits a request for the recorded deed, at step 235. At step 240, pursuant to the user's request, the recording agency transmits the recorded electronic deed 35 embedded in an XML file, along with the recordation information, via network 20. The recording agency maintains a digital image of the electronic deed, which is available to the public. The recordation information and the original electronic deed are each extracted from the XML file, via steps 245 and 250 and the recordation information is affixed to the electronic deed 30, via step 255.

At step 260, the Base64 data stream is removed from the XML file in order to prevent the electronic deed 30 from being subsequently extracted from the XML file a second time. A digital signature may be applied to the electronic deed 30 at step 265 in order to “lock” the document so that the recordation information cannot be altered without invalidating the digital signature. At step 270, the document may again be encrypted in order to prevent unauthorized users from opening the electronic deed 30. The inventive process has created, routed, and recorded an electronic deed. The “original” recorded deed 30 now resides on computer 15, in electronic form.

The original deed may remain stored on computer 15, or the user may request, via step 275, that the original deed be transferred to another storage medium, such as a compact disc or another computer, via step 280. Further, the user may want the original document to be in paper form. In this instance, the original document is printed, and the printed document designated as the “original”. The electronic version of the document is designated as a “copy” in the following manner. Upon printing, a copy is made of the original document, and the copy is time and date stamped by the application of a digital signature to insure that the text cannot be altered. This time and date-stamped document is now the “copy” while the printed version of the document is designated as the “original” document. However, if the user merely wishes to make a copy of the original, electronic document being stored on computer 15, a copy is printed and the stored electronic version of the document remains the “original” without the need of the time and date-stamping process.

The present invention is a method and system that creates an “original” electronic document on a first computer, transmits the electronic document over a communication network, where the document is received by a second computer. Upon transmission of the document, the first computer alters the electronic document in order to differentiate the document currently on the first computer with the document just transmitted over the network. The “altering” may be accomplished by the application of digital text on the document. Thus, at no time is there more than one “original” document in existence. The “original” document, now affixed with recordation information, is transmitted back to the first computer, or another computer designated by the closing or title agent as an approved receiving computer, where it is encrypted and stored in electronic form as the original recorded document.

In an alternate embodiment, the original electronic document received from the second computer may be printed. Upon printing, the stored document is altered by the inventive process, and the printed document is designated as the “original” document. In one embodiment of the invention, the electronic document is an electronic deed and the second computer represents a server at a County Recorder's office. The County Recorder performs the task of recording the deed and sending the recorded deed back to the sender's computer, or a designated computer. As described above, upon the sending the deed to the Recorder's computer, the document stored on the sender's computer is altered to be visually different from the transmitted document. Thus, the present invention advantageously assures that at no time can a third party claim to possess the “original” signed deed. The present invention eliminates that scenario since the transmitted document (ultimately recorded) is no longer identical to the document stored on the sender's computer since it was electronically and irreversibly altered as soon as the deed was transmitted to the second computer.

The present invention can be realized in hardware, software, or a combination of hardware and software. An implementation of the method and machine readable medium of the present invention can be realized in a centralized fashion in one computer system, or in a distributed fashion where different elements are spread across several interconnected computer systems. Any kind of computer system, or other apparatus adapted for carrying out the methods described herein, is suited to perform the functions described herein.

A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which, when loaded in a computer system is able to carry out these methods.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. Significantly, this invention can be embodied in other specific forms without departing from the spirit or essential attributes thereof, and accordingly, reference should be had to the following claims, rather than to the foregoing specification, as indicating the scope of the invention.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A method of processing an electronic document in an electronic document recordation system to assure the existence of only one original electronic document, the method comprising:
storing an original electronic document on a source computer;
submitting the original electronic document for recordation; and
upon verification that the original electronic document has been submitted for recordation,
designating the stored electronic document on the source computer as a copy of the original electronic document.

2. The method of claim 1, wherein submitting the original electronic document for recordation includes transmitting the original electronic document to a destination computer.

3. The method of claim 2, wherein the original electronic document is transmitted to the destination computer via a communication network.

4. The method of claim 2, further comprising:
receiving from the destination computer an electronic file containing at least the original electronic document, and storing the electronic file on the source computer.

5. The method of claim 1, wherein the original electronic document includes embedded text blocks within the original electronic document.

6. The method of claim 1, further comprising calculating recordation fees.

7. The method of claim 1, wherein designating the stored original electronic document on the source computer as a copy further includes time and date stamping the stored original electronic document by application of a digital signature to insure that text cannot be altered on the stored original electronic document without invalidating the digital signature.

8. The method of claim 4, wherein receiving the electronic file containing at least the original electronic document includes extracting the original electronic document from the electronic file.

9. The method of claim 8, further comprising affixing recordation information to the extracted electronic document.

10. The method of claim 8, further comprising transferring the original electronic document to an alternate medium.

11. The method of claim 10, wherein the alternate medium is another computer.

12. The method of claim 10, wherein the alternate medium is a portable data storage device.

13. The method of claim 10, wherein the alternate medium is a printed document.

14. The method of claim 13, wherein upon converting the original electronic document to an alternate medium, further comprising designating the extracted original electronic document as a copy by time and date stamping the original electronic document with application of a digital signature to insure that text cannot be altered on the original electronic document without invalidating the digital signature.

15. A machine readable medium having instructions stored thereon for execution by a processor to perform a method of processing an electronic document in an electronic document recordation system to assure the existence of only one original electronic document, the method comprising:
storing an original electronic document on a source computer;
submitting the original electronic document for recordation; and
upon verification that the original electronic document has been submitted for recordation,
designating the stored electronic document on the source computer as a copy of the original electronic document.

16. The method of claim 15, wherein submitting the original electronic document for recordation includes transmitting the original electronic document to a destination computer.

17. The method of claim 16, wherein the original electronic document is transmitted to the destination computer via a communication network.

18. The method of claim 16, further comprising receiving from the destination computer an electronic file containing at least the original electronic document and storing the electronic file on the source computer.

19. The method of claim 15, wherein the original electronic document includes embedded text blocks within the original electronic document.

20. The method of claim 15, further comprising calculating recordation fees.

21. The method of claim 15, wherein designating the stored original electronic document on the source computer as a copy further includes time and date stamping the stored original electronic document by application of a digital signature to insure that text cannot be altered on the stored original electronic document without invalidating the digital signature.

22. The method of claim 18, wherein receiving the electronic file containing at least the original electronic document includes extracting the original electronic document from the electronic file.

23. The method of claim 18, further comprising affixing recordation information to the extracted electronic document.

24. The method of claim 18, further comprising time and date stamping the extracted electronic document to prevent alteration of the recordation information.

25. A system for processing an electronic document in an electronic document recordation system to assure the existence of only one original electronic document, the system including a source computer connected to a destination computer via a data communications network, the system comprising:
the source computer for storing an original electronic document, the source computer including means for transmitting the original electronic document to the destination computer over the data communication network; and
means for designating the stored electronic document on the source computer as a copy of the original electronic document, upon verification that the original document has been transmitted to the destination computer.
